(19) United States
(12) Patent Application Publication
(10) Pub. No.: US 2026/0170660 A1
(43) Pub. Date: Jun. 18, 2026

(54) LASER SHOOTING TRAINING SYSTEM, METHOD, AND INTEGRATED RECOGNITION APPARATUS

(71) Applicant: Jian Ou, Beijing (CN)

(72) Inventors: Lingxiao Ou, Dongguan (CN); Yanqin Luo, Dongguan (CN)

(21) Appl. No.: 19/529,044

(22) Filed: Feb. 3, 2026

(30) Foreign Application Priority Data
Dec. 12, 2025 (CN) 202522644328.3

(51) Int. Cl. G06T 7/194; G06T 7/80

(52) U.S. Cl. CPC G06T 7/194; G06T 7/80

(57) ABSTRACT

The present disclosure provides a laser shooting training system, a method, and an integrated recognition apparatus, belonging to the field of intelligent shooting training technology. The system comprises a user terminal and at least one integrated recognition apparatus. The integrated recognition apparatus comprises a target face, an image acquisition module, a processor, and a rigid support structure. The rigid support structure fixedly connects the image acquisition module and the target face, maintaining a preset optical path and elevation angle without calibration. The processor is configured to achieve precise recognition and anti-interference processing of different colored laser points projected on the target face through a specialized image processing algorithm combined with a lightweight neural network. The present invention supports multi-target collaborative networking and achieves plug-and-play functionality and high environmental adaptability through the combination of a fixed optical path structure and adaptive algorithms.

### TECHNICAL FIELD

The present disclosure relates to the technical field of intelligent shooting training equipment, and more particularly, to a laser shooting training system, a method, and an integrated recognition apparatus, which are especially suitable for dry fire training scenarios.

### BACKGROUND

In the field of Dry Fire Training, laser point recognition technology is the core for achieving shooting effect feedback. Existing laser training technologies mainly fall into two categories, but both have significant drawbacks.

The first category is based on smartphone applications (Apps). This solution captures target images by invoking the smartphone camera. However, since the distance and angle between the phone and the target are not fixed, complex geometric calibration is required before each use. Furthermore, recognition accuracy relies heavily on the phone's hardware performance and environmental lighting. Additionally, such Apps typically require an internet connection to operate, posing a risk of training data privacy leakage. Moreover, the training process is easily interrupted by incoming calls or notifications, affecting training continuity.

The second category is the professional electronic target solution. Although such devices offer higher accuracy, they are generally bulky, structurally complex, and rely on fixed power supplies. They are mainly suitable for professional shooting ranges and are difficult to meet the portability needs of home users or outdoor mobile training.

Therefore, there is an urgent need for a laser shooting training technical solution that requires no complex calibration, has strong environmental adaptability, ensures data security, and is portable.

### SUMMARY

The purpose of the present disclosure is to provide a laser shooting training system and an integrated recognition apparatus, which achieve plug-and-play functionality, high-precision recognition, and multi-target collaborative training through a fixed optical path structural design and specialized algorithms.

To achieve the above objectives, the present disclosure adopts the following technical solutions:

A laser shooting training system includes a user terminal and at least one integrated recognition apparatus. The integrated recognition apparatus comprises a target face, an image acquisition module, a processor, and a support structure. The support structure fixedly connects the image acquisition module and the target face, maintaining a preset fixed relative positional relationship, thereby forming a calibration-free imaging optical path. The processor identifies laser points and calculates data through an image processing algorithm and transmits the data to the user terminal via a wireless communication module.

Furthermore, the preset fixed relative positional relationship is preferably such that the distance between the image acquisition module and the target face is 15-20 cm, and the optical axis is perpendicular or nearly perpendicular to the target face.

Furthermore, the processor is configured to execute multi-color laser recognition logic for simultaneously identifying laser points of different colors (e.g., red laser and green laser).

Specifically, the algorithm distinguishes the color type of the laser signal by extracting the intensity distribution differences of the laser point region in respective channels in the RGB color space and marks the color type in the generated hit data.

Furthermore, the image processing algorithm adopts a combination of background subtraction and dynamic threshold segmentation to effectively filter out environmental light interference.

Compared with the prior art, the present disclosure has the following beneficial effects:

Calibration-free, Plug-and-Play: The imaging optical path is solidified through the rigid support structure, allowing users to use the device immediately upon powering on without adjusting distance or angle.

Strong Environmental Adaptability: The specialized algorithm supports stable recognition in environments ranging from low light to strong light (e.g., 50-10,000 lux).

Support for Multi-person Confrontation Training: Based on multi-color laser recognition technology, the system can distinguish shooting inputs from different users (e.g., User A uses red laser, User B uses green laser), thereby realizing competitive confrontation or multi-person teaching scenarios on the same target face.

Data Security: Pure hardware local calculation and storage eliminate the need for uploading to the cloud, preventing privacy leakage.

Multi-target Collaboration: Supports simultaneous connection of multiple recognition apparatuses through the user terminal to realize multi-target training in tactical scenarios.

### BRIEF DESCRIPTION OF THE DRAWINGS

FIG. 1 is a schematic diagram illustrating a perspective structure of an integrated recognition apparatus according to an embodiment of the present disclosure.

FIG. 2 is a schematic diagram illustrating a side optical path principle of the integrated recognition apparatus according to an embodiment of the present disclosure.

FIG. 3 is a block diagram illustrating a system hardware architecture according to an embodiment of the present disclosure.

FIG. 4 is a flowchart illustrating a laser point recognition algorithm according to an embodiment of the present disclosure.

FIG. 5 is a schematic networking diagram of a multi-target collaborative system according to an embodiment of the present disclosure.

FIG. 6 is a front view of a calibration target face according to an embodiment of the present disclosure.

FIG. 7(a) shows a desktop installation, FIG. 7(b) shows a wall-mounted installation, and FIG. 7(c) shows a tripod installation.

### DESCRIPTION OF REFERENCE NUMERALS

1—Image Acquisition and Processing Unit (Base)
2—Image Acquisition Module (Camera)
3—Rigid Support Structure (Connecting Rod)
4—Target Face
5—Visual Marker (Positioning Code)
6—Effective Scoring Area (Target Pattern)
7—Interaction Function Area
8—Universal Mounting Interface
9—External Support Device (Tripod, not part of the present invention)
100A/100B/100C—Integrated Recognition Apparatus (Slave Device)
200—User Terminal (Master Device)
300—Wireless Communication Connection
α—Preset Elevation Angle
L—Fixed Distance

### DETAILED DESCRIPTION

The following clearly and completely describes the technical solutions in the embodiments of the present disclosure with reference to the accompanying drawings.

### Embodiment 1: Hardware Structure of Integrated Recognition Apparatus

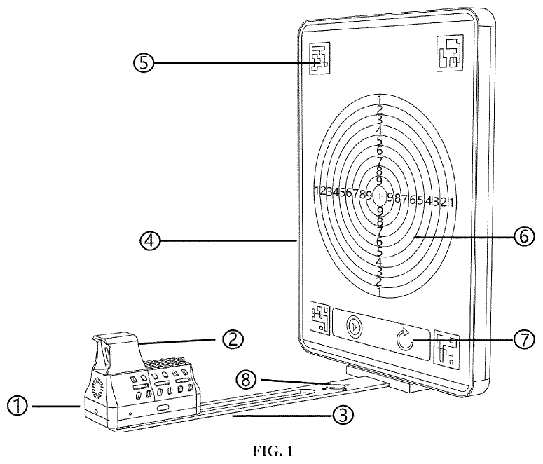

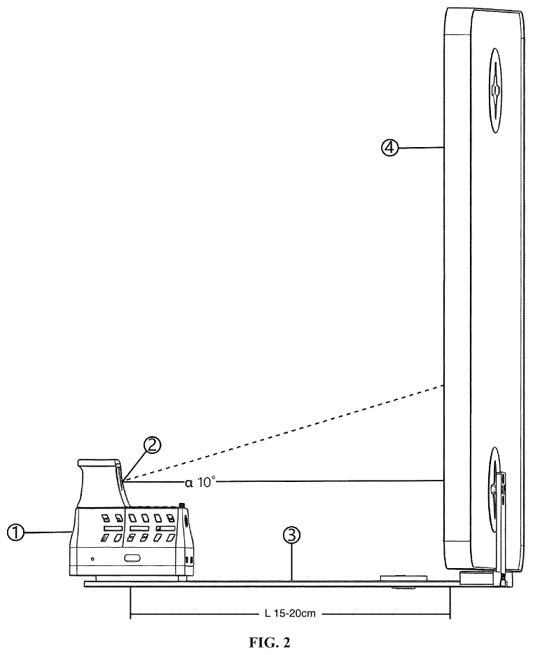

As shown in FIG. 1 and FIG. 6, the present embodiment provides an integrated recognition apparatus, comprising a housing, a customized target frame (i.e., rigid support structure), an image acquisition module, a core processing module, a wireless communication module, and a power module.

### 1. Optical Path Structure Design:

The customized target frame is made of rigid material (such as ABS engineering plastic or aluminum alloy). One end is connected to the housing, and the other end bears the target face. Through this mechanical structure, the image acquisition module (such as an ultra-close fixed-focus camera) is fixed at a preset distance of 15 cm-20 cm from the target face.

Particularly, to prevent the device body from blocking the user's line of sight for aiming at the target face while ensuring imaging quality, the optical axis of the image acquisition module forms an elevation angle of 3 degrees to 10 degrees with the normal direction of the target face. This “preset fixed optical path” design eliminates the geometric calibration steps required in traditional solutions due to random placement.

### 2. Core Hardware Configuration:

The core processing module is integrated inside the housing, including a processor, local flash memory, and communication unit.

Processor: Uses a heterogeneous multi-core architecture, for example, an ARM Cortex-A7 (1.2 GHz frequency) combined with a RISC-V MCU. The MCU is responsible for low-power sensor wake-up, and the ARM core is responsible for high-load image computing.

Neural Network Acceleration: The processor integrates an NPU (Neural Processing Unit) or is optimized through DSP instruction sets to run lightweight convolutional neural networks.

Interface and Power: The apparatus integrates an HDMI 1.4 interface, supporting the output of real-time target images to an external monitor. The power module uses a replaceable 18350 lithium battery and supports USB-C charging.

### 3. Mounting Interface:

The bottom of the housing is provided with a ¼-inch standard threaded hole, suitable for universal tripods. The back is provided with a strong magnetic module and hanging holes. Users can choose desktop, wall-mounted, or stand-mounted setups according to the environment, and the aforementioned optical path structure remains unchanged regardless of the installation method.

### Embodiment 2: Laser Point Recognition Algorithm and Multi-Color Logic

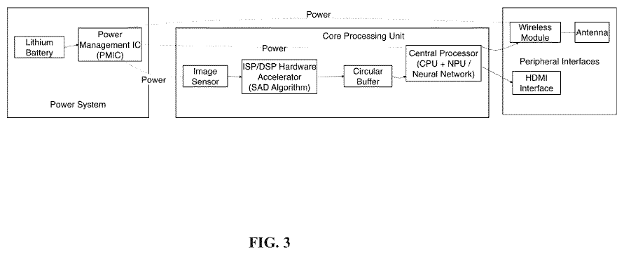

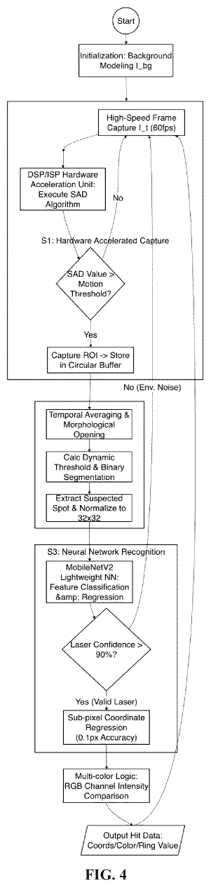

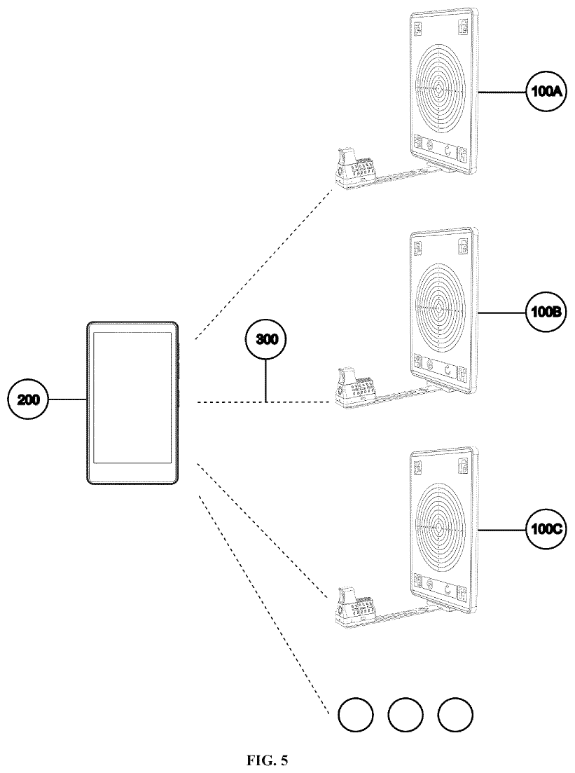

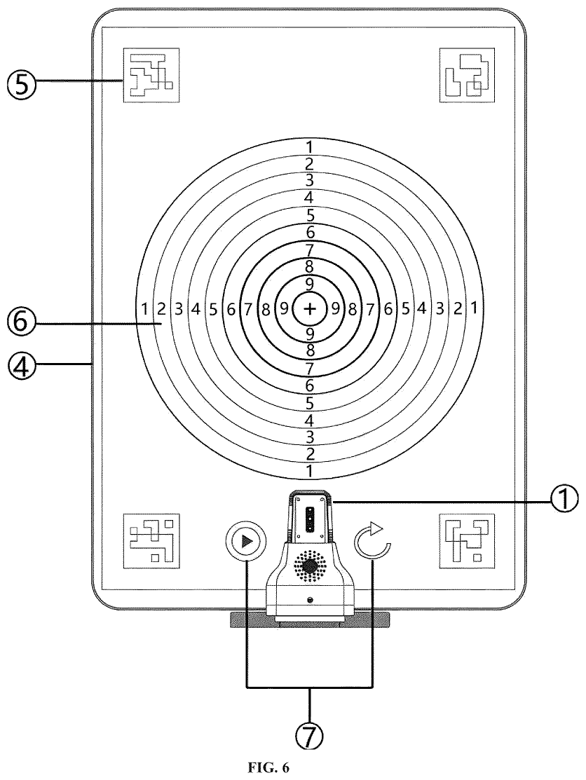

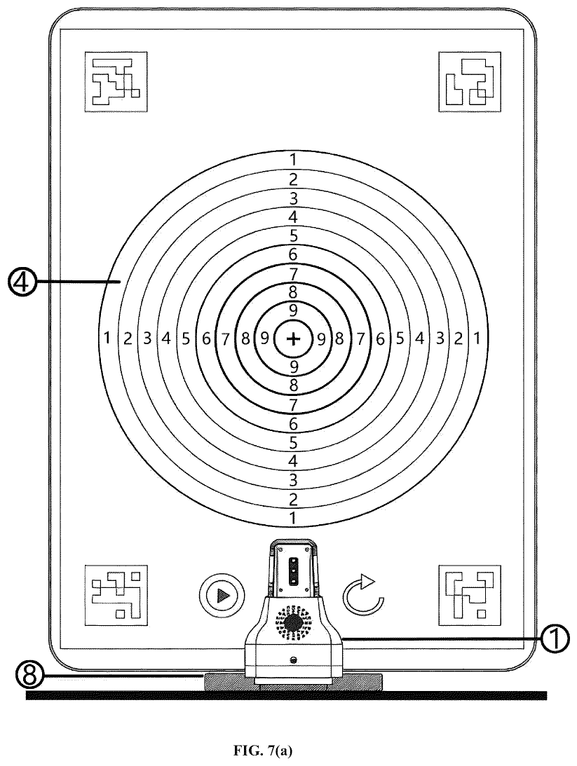

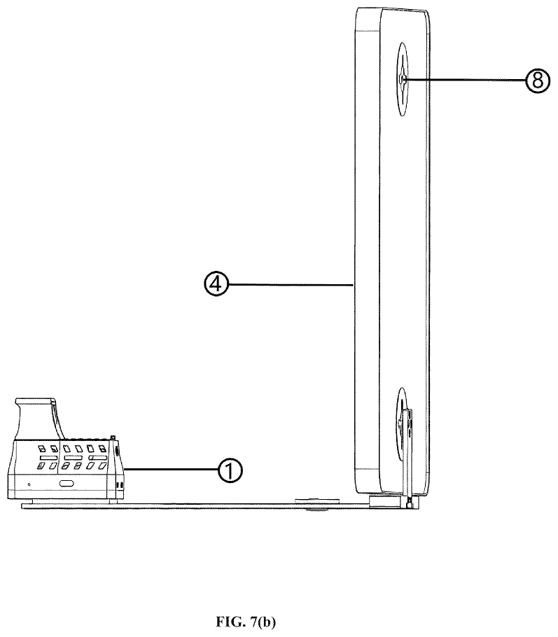

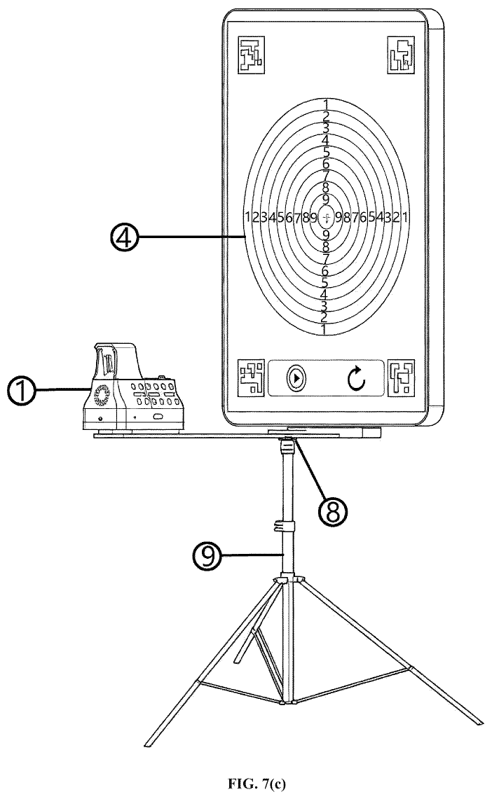

As shown in FIG. 3 (hardware block) and FIG. 4 (flowchart), the core processor works in coordination with the hardware acceleration unit and the neural network engine to execute the following steps S1-S3 to achieve high-speed and high-precision laser point positioning:

### S1: High-Speed Moving Region Capture Based on Hardware-Accelerated SAD

To reduce CPU load at 60 fps or higher frame rates, the processor invokes an internal DSP/ISP hardware acceleration unit to execute the Sum of Absolute Differences (SAD) algorithm.

Specifically, the current frame image Iₜ is compared with a background reference image I_{bg} block by block. For any pixel block (x,y) in the image, the SAD value is calculated as:

$$SAD ( x , y ) = i = 0 \sum N - 1 j = 0 \sum N - 1 \vert It ( x + i , y + j ) - Ibg ( x + i , y + j ) \vert$$

Where N is the block size (preferably 8×8 or 16×16).

When the SAD(x,y) of a certain region is greater than a preset motion threshold Tₘₒₜᵢₒₙ (e.g., 1500), it is determined that a moving target (i.e., a potential laser point) exists in that region. The system immediately captures the Region of Interest (ROI) and stores it in a Circular Buffer with a depth of K (e.g., K=5).

### S2: Temporal Correlation Extraction and Morphological Preprocessing

The ROI image group {R₁, R₂, . . . , R_{K}} at the same position in consecutive K frames is extracted from the circular buffer, and temporal superposition averaging is performed to eliminate random electronic noise, obtaining an enhanced region image R_{avg}.

Subsequently, a morphological opening operation (erosion followed by dilation) is performed on R_{avg} to separate connected noise points and smooth the light spot edges. The morphological formula is:

$${I}_{c l e a n} = ( {R}_{a v g} ⊖ B ) ⊕ B$$

Where B is a 3×3 structuring element. Then, a dynamic threshold T_{dyn} is calculated for binary segmentation:

$${T}_{d y n} = μ ( {I}_{c l e a n} ) + β \cdot σ ( {I}_{c l e a n} )$$

Where μ is the regional mean, σ is the standard deviation, and β is a sensitivity coefficient (preferably 2.5). After binarization, a high-brightness light spot mask is extracted.

### S3: Lightweight Neural Network Recognition and Sub-Pixel Positioning

The suspected light spot region extracted in step S2 is normalized to 32×32 pixels and input into a MobileNetV2 lightweight neural network model trained for specific scenes. The network is pruned and optimized, and the output layer contains two branches:

Classification Branch: Outputs the confidence Pthat the region is a “valid laser.” Only when P>0.95 (95%) is it determined as a valid shot, thereby thoroughly filtering out environmental noise such as sunlight reflections and metal highlights.

Regression Branch: Unlike the traditional centroid method, this branch directly predicts the sub-pixel level coordinates (\hat{x},ŷ) of the energy center of the laser beam. The prediction performs regression based on the energy Gaussian distribution characteristics of the light spot. The formula is expressed as a network mapping function:

$$( \hat{x} , \hat{y} ) = {f}_{C N N} ( {I}_{i n p u t} \vert θ )$$

Where θ represents the trained network weight parameters. This method can improve positioning accuracy from the integer pixel level to the 0.1 pixel (Sub-pixel) level, ensuring that the converted ring value error is less than 0.5 mm under close-range shooting of 15-20 cm.

### Embodiment 3: Experimental Data Verification

To verify the beneficial effects of the present invention, a comparative test was conducted between the present apparatus and a mainstream smartphone APP solution under different lighting environments.

TABLE 1
Recognition Accuracy Comparison

| Ambient Light | Scene | Smartphone APP | Present Apparatus |
|---|---|---|---|
| Intensity (Lux) | Description | Recognition Rate | Recognition Rate |
| 50 Lux | Indoor Dim | 85.3% | 99.6% |
| 500 Lux | Indoor Normal | 92.1% | 99.9% |
| 5000 Lux | Outdoor Cloudy | 45.6% | 98.5% |
| 10000 Lux | Outdoor Strong | 0% | 96.2% |
| | Light | | |

The experimental results show that, benefiting from the fixed optical path structure, specialized filtering algorithm, and the introduction of neural networks, the recognition rate of the present invention in outdoor strong light environments is significantly superior to existing smartphone APP solutions.

### Embodiment 4: Multi-target Collaborative Training Mode

The system supports controlling various training modes via the user terminal (e.g., smartwatch):

Sequential Shooting Mode: The terminal lights up different targets according to preset logic to train the user's tactical movement ability.

Random Challenge Mode: Randomly activates targets to train the user's reaction speed.

Confrontation Mode: Based on the multi-color recognition logic in Embodiment 2, two users use red/green lasers respectively to shoot at the same or different targets, and the system statistically counts their respective scores in real-time and displays them on a split screen on the terminal.

What is claimed is:

1. A laser shooting training system, comprising:
a user terminal; and at least one integrated recognition apparatus communicatively connected to the user terminal via a wireless communication module;
wherein the integrated recognition apparatus comprises a target face, an image acquisition module, a processor, and a support structure;
wherein the support structure fixedly connects the image acquisition module and the target face, maintaining a preset fixed distance between an optical axis of the image acquisition module and the target face, and forming a preset elevation angle between the optical axis and a normal direction of the target face, thereby establishing a calibration-free imaging optical path;
wherein the processor is configured to identify a laser point projected on the target face via an image processing algorithm, calculate hit data, and transmit the hit data to the user terminal via the wireless communication module; and
wherein the user terminal is configured to receive and display the hit data.

2. The laser shooting training system according to claim 1, wherein the preset elevation angle is in a range of 3° to 10° to prevent a body of the integrated recognition apparatus from obstructing a user's aiming line of sight toward the target face; and wherein a preset fixed relative positional relationship comprises a vertical distance between the image acquisition module and the target face being 15 cm to 20 cm, and the image acquisition module is configured in a fixed-focus shooting mode such that the target face is completely covered within a field of view of the image acquisition module.

3. The laser shooting training system according to claim 1, wherein the image processing algorithm is configured to perform operations comprising:
S1: capturing a moving region in a current frame at high speed based on a hardware-accelerated Sum of Absolute Differences (SAD) algorithm and a background subtraction algorithm, and capturing a same moving region from buffered consecutive multiple frames into a circular buffer;
S2: extracting a group of temporally correlated captured regions from the circular buffer to perform morphological opening operations, calculating a dynamic threshold, and performing binary segmentation to extract a suspected light spot region;
S3: inputting the suspected light spot region into a scene-specialized trained lightweight neural network model (MobileNetV2) for recognition, filtering out environmental noise to purify a valid laser spot, and predicting a starting position coordinate of a laser beam with sub-pixel level accuracy to complete high-precision laser point positioning; and
S4: calculating centroid coordinates of a valid laser point region and mapping the coordinates to a target face ring value.

4. The laser shooting training system according to claim 3, wherein the dynamic threshold is calculated based on a product of an average pixel value of a difference image and a preset coefficient to adapt to environmental light of different intensities.

5. The laser shooting training system according to claim 1, wherein the processor is further configured to identify laser points of a plurality of different colors;
wherein a recognition process comprises: extracting intensity values of respective channels of a laser point region in an RGB color space, and determining a color type of the laser point based on channel intensity distribution differences; and
wherein the hit data includes an identifier of the color type.

6. The laser shooting training system according to claim 1, wherein the support structure is provided with a plurality of universal mounting interfaces, comprising:
a bottom threaded hole for connecting to a tripod;
a back hanging hole or magnetic structure for wall-mounted installation; and
a bottom anti-slip flat surface for horizontal placement;
wherein a relative positional relationship between the image acquisition module and the target face remains unchanged regardless of which installation method is adopted.

7. The laser shooting training system according to claim 1, wherein the user terminal is one of a smartwatch, a smartphone, a tablet computer, or a dedicated portable display device; and wherein the user terminal acts as a master device configured to simultaneously establish connections with a plurality of said integrated recognition apparatuses and perform fusion processing on hit data from different integrated recognition apparatuses.

8. The laser shooting training system according to claim 1, wherein the system supports a plurality of interactive training modes, and the user terminal is configured to control the training modes, comprising:
a sequential shooting mode: guiding a user to hit different logical targets in a specific order;
a random challenge mode: activating random targets at random time points to require rapid shooting by the user; and
a confrontation mode: statistically counting a sum of scores of laser points of different colors within a same time period.

9. The laser shooting training system according to claim 1, wherein the target face is provided with at least one visual marker; and wherein the processor is configured to identify the visual marker upon startup to establish a mapping relationship between a pixel coordinate system and a physical coordinate system.

10. The laser shooting training system according to claim 1, wherein the integrated recognition apparatus further comprises an HDMI video output interface for outputting a real-time target face image superimposed with a hit position marker to an external display device.

11. An integrated recognition apparatus for laser shooting training, comprising:
a target face interface configured to bear or form a target face;
an image acquisition module configured to capture an image of the target face;
a rigid connector configured to maintain the image acquisition module and the target face interface at a fixed spatial distance and angle, enabling operation without user calibration;
a processor configured to execute instructions to identify a laser point from the image and generate coordinate data; and
a wireless communication module configured to transmit the coordinate data;
wherein the rigid connector fixes the image acquisition module at a front lower position of the target face interface to shoot at an elevation angle of 3° to 10°; and
wherein the processor comprises a built-in neural network acceleration unit for executing a laser point recognition algorithm.
